(19) United States
(12) Patent Application Publication
(10) Pub. No.: US 2002/0194940 A1
(43) Pub. Date: Dec. 26, 2002

(54) Axial adjusting device having improved driving pinion

(76) Inventors: Holger Seidl, Siegburg (DE); Karl-Heinz Hulsebusch, Koln (DE); Raymond LeGallais, Birmingham (GB)

Correspondence Address: Robert P. Renke, 28333 Telegraph Road, Suite 250, Southfield, MI, 48034, US

(21) Appl. No.: 10/175,269

(22) Filed: Jun. 19, 2002

(30) Foreign Application Priority Data
Jun. 20, 2001 (DE) 101 29 794.7

(51) Int. Cl. F16H 19/02

(52) U.S. Cl. 74/89.16

(57) ABSTRACT

An axial adjusting device including two discs (24, 29) which are rotatable relative to one another and coaxially supported relative to one another, between which discs (24, 29) and balls (35) are guided in pairs of ball grooves (34, 39) in the discs (24, 29), wherein the depth of the pairs of ball grooves (34, 39) is variable across the circumference of the discs; one of the discs (24, 29) is axially supported and one is axially displaceable against the returning forces of a resilient spring mechanism and at least one is drivable by a motor (11) which is incorporated into a housing (52) and whose motor shaft (12) is connected to a driving pinion (15), wherein the driving pinion includes a journal projection (16) which runs in a bearing (17) which is supported in the housing (52).

### TECHNICAL FIELD

The present invention relates to an axial adjusting device. In particular, the invention concerns an axial adjusting device having an improved driving pinion arrangement.

### BACKGROUND OF THE INVENTION

The invention relates to an axial adjusting device of the type comprising two discs which are rotatable relative to one another and co-axially supported relative to one another. Between the discs, balls are guided in pairs of ball grooves in the discs. The depth of the pairs of ball grooves is variable across the circumference of the discs. One of the discs is axially supported, and one is axially displaceable against the returning forces of a resilient spring mechanism. At least one of the discs is drivable by a motor which is incorporated into a housing and whose motor shaft is connected to a driving pinion.

The axial adjusting device is actuated by operating the driving motor, whereby the at least one of the discs which is either coupled to the driving motor directly or via reduction stages is rotated and the axially displaceable disc supporting itself via balls on the axially supported disc is axially displaced against resilient returning forces.

The rotatingly driven disc can, at the same time, be the axially displaceable disc, but this is typically not the case. Normally, the axially supported disc is rotatingly driven and the axially displaceable disc supporting itself via balls on the axially supported disc is held in a rotationally fast way.

The balls rest against end stops in the pairs of ball grooves and, at the same time, are positioned therein in the deepest groove portions. Because the discs rotate relative to one another, the balls move towards the shallower groove portions during rotation. As a result, the discs are pushed away from one another.

When the motor is switched off, the displaceable disc is pushed back as a result of the resilient returning force of the spring mechanism and the at least one rotatingly drivable disc is reversed due to the ramp effect of the ball grooves. The rotatable disc drives the freely rotating motor shaft via the driving pinion back into the starting position until the balls simultaneously stop against the end stops in their pairs of ball grooves. As a result of the balls stopping against the ends of the ball grooves, the rotating masses of this system, i.e. the rotatable discs and optionally the gears of the reduction gear, as well as the motor shaft of the motor, are stopped abruptly.

The motor shaft is supported via two bearings in the motor housing. As the pinion is mounted outside the bearings, it is possible for the tooth forces at the pinion to bend the motor shaft like a doubly supported bending beam. Even elastic deformation of the motor shaft as a result of the pulse generated by the rotating masses stopping abruptly can lead to gear fracture at the pinion or at the set of gears, because the bending of the motor shaft causes the force application points in the toothings to move radially outwards. This means that the pinion or the set of gears can be subjected to loads which are higher than the design loads.

### SUMMARY OF THE INVENTION

It is therefore an object of the present invention to provide a design which is able to accommodate, in a damage-free way, the pulses generated when the above-mentioned rotating masses are braked. In the present invention, the driving pinion contains a journal projection which runs in a bearing which is supported in the housing. In this way, motor shaft bending as mentioned above is either prevented or greatly reduced. The bearing can be a friction bearing or a rolling-contact bearing, such as a needle bearing. According to a preferred embodiment, when the pinion is not subjected to loads, the journal projection rests in the housing in a contact-free way, with the bearing gap being as small as possible. In this way, it is possible to prevent motor shaft torsion being caused by a third bearing point in case there are production inaccuracies. However, the bearing gap has to be small enough to ensure that, when tooth forces occur, the motor shaft is not plastically deformed and that any elastic deformation of the motor shaft does not lead to tooth fracture in the pinion.

According to an advantageous embodiment, the motor and the additional bearing are accommodated in one single housing part, so that, in particular, it is possible to produce a centering bore for the housing of the motor and the bearing bore for the additional bearing in one mounting position.

According to another embodiment, the pinion is positioned between the end of the motor shaft and the additional bearing. In consequence, the pinion is supported between the last motor shaft bearing and the additional bearing, so that any bending as a result of tooth forces is almost impossible.

According to another embodiment, the additional bearing is positioned between the end of the motor shaft and the pinion. Herein the pinion is supported from one end and the additional bearing point can be close to the motor drive.

Preferred embodiments of the invention are illustrated in the drawings and will be described below. Other advantages and features of the invention will become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows an axial adjusting device according to an embodiment of the present invention, including the motor in its entirety.

FIG. 2 shows a motor drive pinion according to a first embodiment of the present invention in the form of a detail.

FIG. 3 shows the additional bearing of the device according to FIG. 2 in the form of an enlarged detail.

FIG. 4 shows a motor drive pinion according to a second embodiment of the present invention in the form of a detail.

FIG. 5 shows the additional bearing of the device according to FIG. 4 in the form of an enlarged detail.

### DETAILED DESCRIPTION OF THE INVENTION

In the following description, various operating parameters and components are described for one constructed embodiment of the axial adjusting device. These specific parameters and components are included as examples and are not meant to be limiting. That is, the drive pinion arrangement described below can be advantageously employed in other motor drive shaft applications, including other axial adjusting device arrangements as will be understood to one of skill in the art.

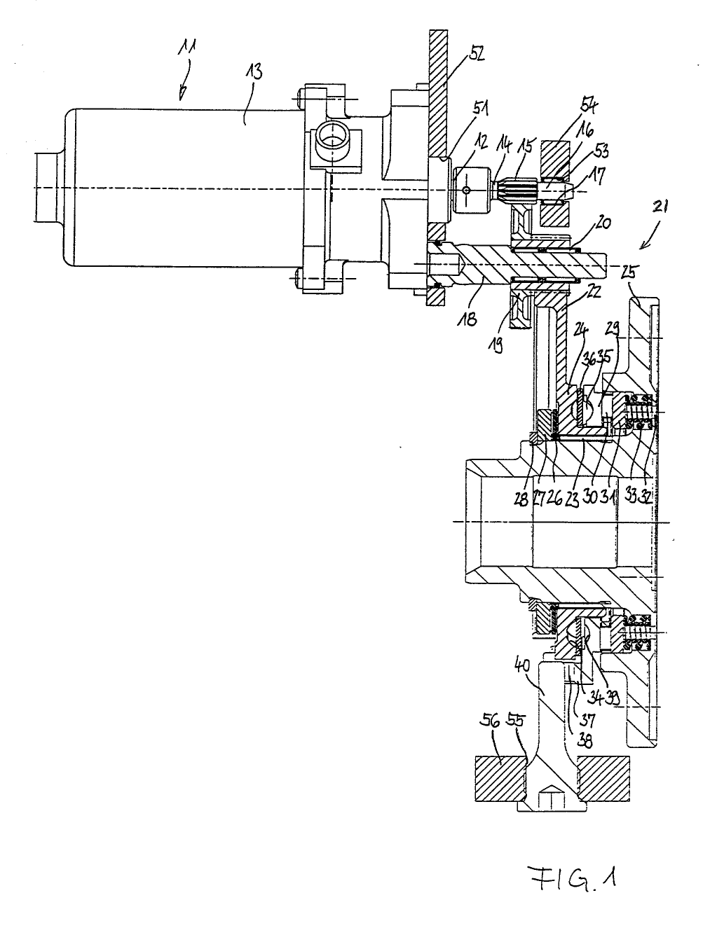

FIG. 1 shows a motor 11 in a mounted condition, together with an axial adjusting device 21. The motor 11 and the axial adjusting device 21 cooperate together to convert rotational movement into a linear translation to engage, for example, a locking coupling in a differential drive. At the motor 11, the end of the motor shaft 12 extends from the motor housing 13. The motor housing 13 is inserted into a centering bore 51 in a housing wall 52. A shaft journal 14 forming the pinion 15 is positioned on the motor shaft 12. A journal projection 16 on the shaft journal is supported via a needle bearing 17 in a bearing bore 53 in a housing wall 54. A fixed bearing journal 18 is inserted into the housing wall 52, with a stepped gear 19 being rotatably supported on the bearing journal 18 via a double-row needle bearing 20. By way of its larger gear rim, the stepped gear 19 engages the pinion 15 on the shaft 12. Furthermore, by way of its smaller gear rim, the stepped gear 19 engages a tooth segment 22 which is firmly connected to a first disc 24 of the adjusting device. Via a needle bearing 23, the first disc 24 is supported so as to be rotatable relative to a projection at a cover 25 on which the first disc 24 is axially supported via an axial bearing 26, a disc 27 and a securing ring 28. The first disc 24 cooperates with a second disc 29 which, via an axial bearing 30 and a disc 31, acts on pressure pins 32, with the disc 31 being supported via a resilient spring mechanism in the form of pressure spring 33 on the cover 25. In the faces of the first and second discs 24, 29 which face one another, there are provided pairs of grooves 34, 39 whose depth varies across the circumference of the discs and in which there are held balls 35 which are arranged in a ball cage 36. The second disc 29 comprises a radial projection 37 with a guiding claw 38. The guiding claw 38 slides in a longitudinally movable way on a holding pin 40 which is firmly inserted into a bore 55 in a housing wall 56 and which, in this way, holds the second disc 29 in a rotationally fast way. When the first disc 24 rotates, the second disc 29 is axially displaced on the cover 25 against the returning force of the springs 33 by the balls 35 which move from deeper ball groove regions to shallower ball groove regions. The cover 25 normally forms part of the coupling carrier of a locking coupling in a differential drive.

The ball and ball groove arrangement can alternatively comprise roller bearings operatively positioned between the first and second discs 24, 29 accommodated in ramped surfaces, or a cam and roller arrangement between either flat or ramped end faces of the opposing first and second discs 24, 29 to convert rotational movement of one disc into translational movement along the axial direction of the other disc. Such mechanisms will be referred to herein as rotational translational means.

The motor is normally a frequency-modulated electric motor. All the housing walls 52, 54, 56 can be part of an on-part housing and the bores 51 and 53 can be produced in one clamping arrangement.

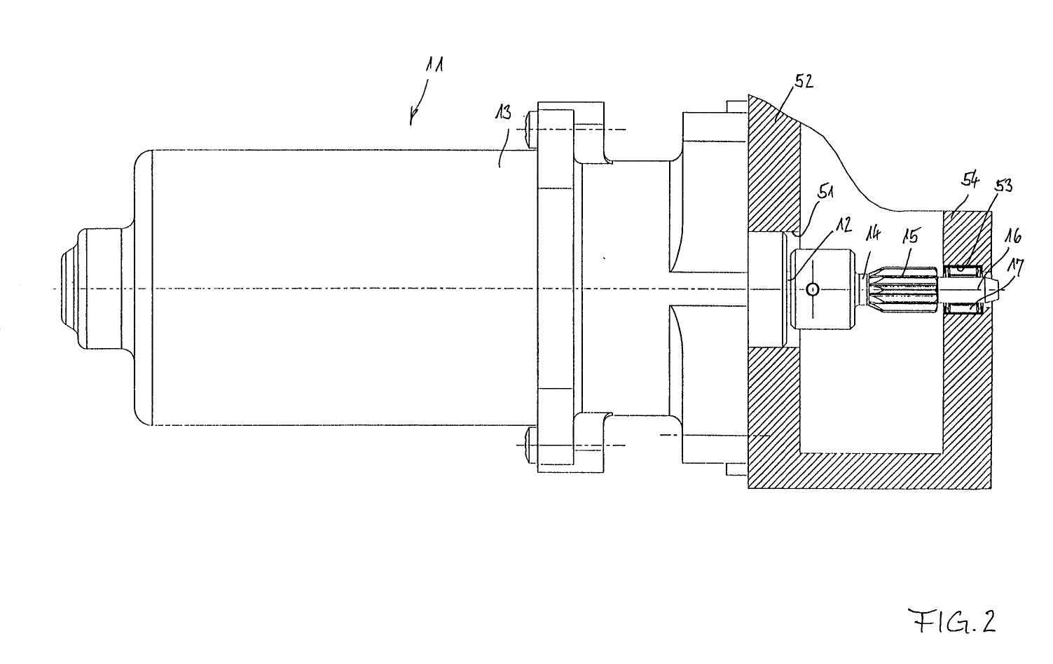

FIG. 2 shows a motor 11 whose driveshaft 12 is supported at least twice in the motor housing 13. The motor housing 13 is inserted into the centering bore 51 in the housing wall 52. The shaft journal 14 carrying the driving pinion 15 is positioned on the motor shaft 12. In the region beyond the pinion, the shaft journal 14 forms the journal projection 16 which is supported via a needle bearing 17 in the bearing bore 53 in the further housing wall 54.

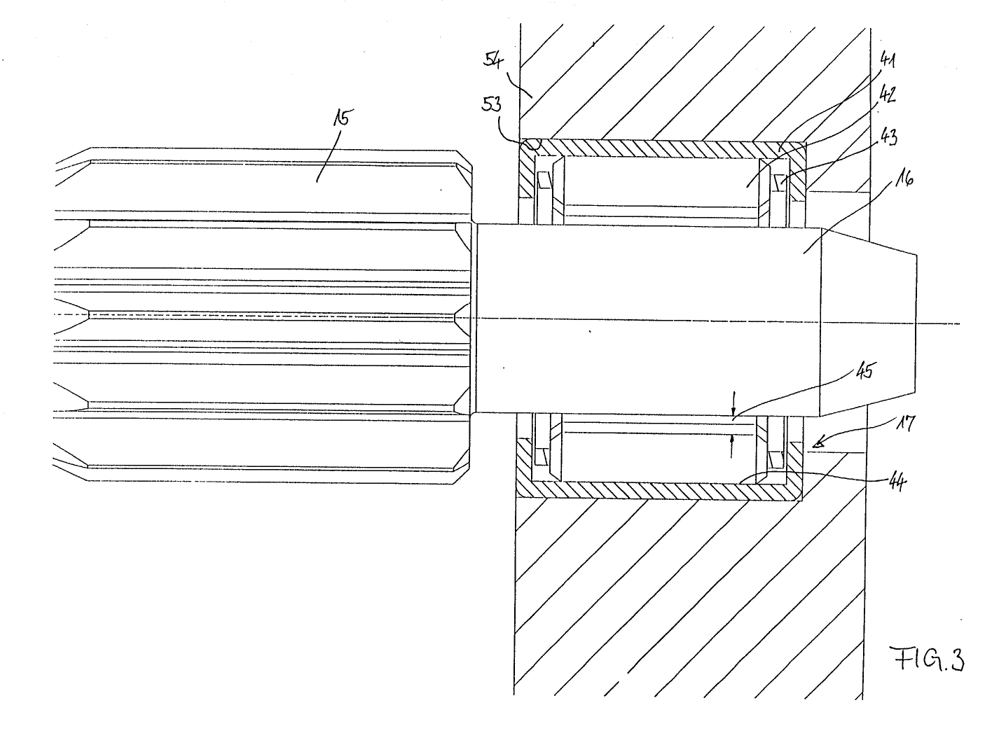

FIG. 3 shows the additional bearing for the journal projection 16 at the pinion 15 in the form of an enlarged detail. The needle bearing 17 with an outer bearing race 41 is inserted by a press fit into the bearing bore 53 in the housing wall 54. The needle bearings 42 held in a needle cage 43 run, with contact, on the inner face 44 of the outer bearing race 41, but form a radial gap 45 relative to the unloaded journal projection 16. When the journal projection is radially deflected, the bearing needles establish direct contact therewith.

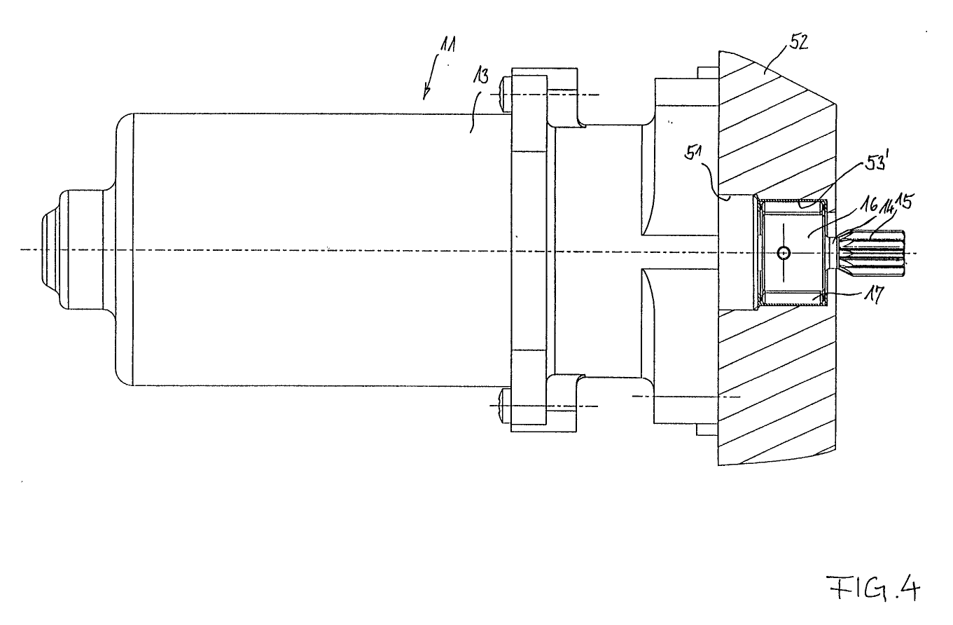

FIG. 4 shows a motor 11 whose motor shaft 12 is also supported at least twice in the motor housing. The motor housing 13 is inserted into the centering bore 51 in the housing wall 52. A solid journal projection 16 carrying a driving pinion 15 is positioned on the end of the motor shaft 12. The journal projection 16 is supported via a needle bearing 17 in a bearing bore 53′ in the housing wall 52.

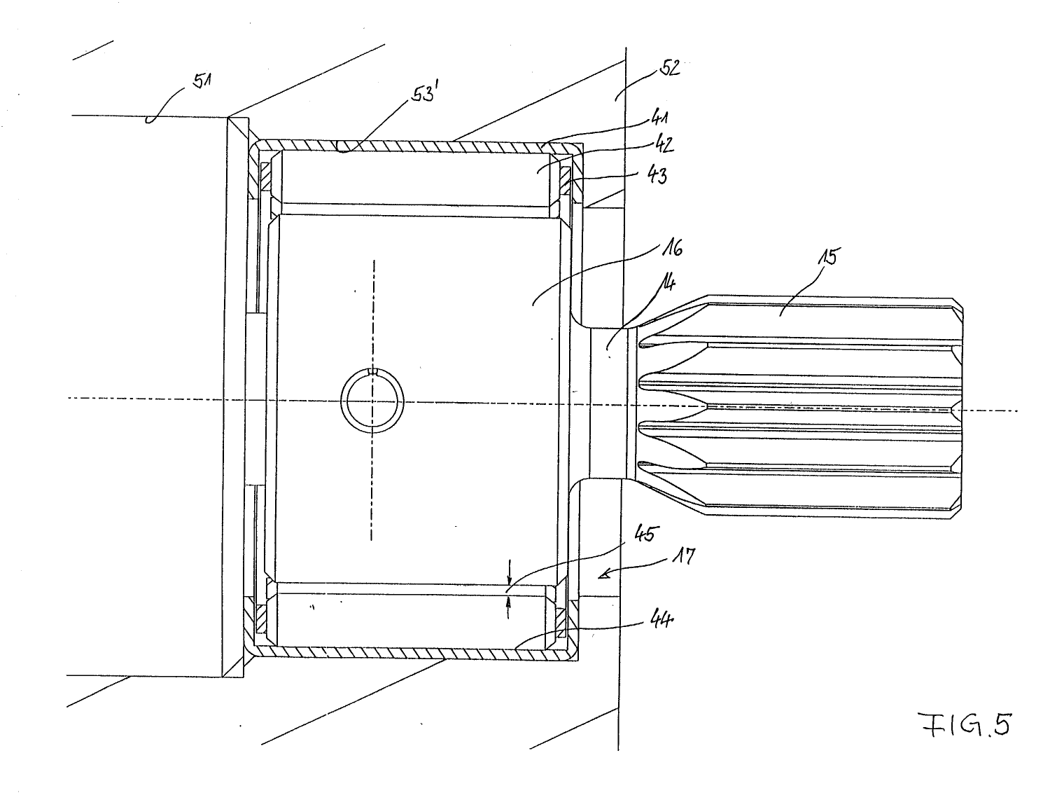

FIG. 5 shows the additional bearing for the journal projection 16 at the pinion 15 in the form of an enlarged detail. The needle bearing 17 with an outer bearing race 41 is inserted by a press fit into the bearing bore 51 in the housing wall 52. The needle bearings 42 held in a needle cage 43 run, with contact, on the inner face 44 of the outer bearing race, but form a radial gap 45 relative to the unloaded journal projection 16. When the journal projection is radially deflected, the bearing needles establish direct contact therewith.

From the foregoing, it can be seen that there has been brought to the art a new and improved pinion drive for an axial adjusting device and motor. While the invention has been described in connection with one or more embodiments, it should be understood that the invention is not limited to those embodiments. For example, the ball and groove arrangement disclosed can alternatively be a roller bearing arrangement, and the spring mechanism 33 can also differ from the helical pressure springs shown. Such modifications, as well as others which are readily apparent are contemplated by the present invention. Thus, the invention covers all alternatives, modifications, and equivalents as may be included in the spirit and scope of the appended claims.

What is claimed is:

1. An axial adjusting device comprising: first and second discs which are rotatable and coaxially supported relative to one another; and balls between said first and second discs which are guided in pairs of ball grooves in said first and second discs, wherein the depth of said pairs of ball grooves is variable across the circumference of the first and second discs, and wherein one of the first or second discs is axially supported and one is axially displaceable against returning forces of a resilient spring mechanism and at least one is drivable by a motor which is incorporated into a housing, said motor including a motor shaft connected to a driving pinion, wherein the driving pinion comprises a journal projection which runs in a bearing which is supported in the housing.

2. A device according to claim 1 wherein, when the pinion is not subjected to loads, the journal projection rests in the bearing in a contact-free way.

3. A device according to claim 1, wherein the motor and the bearing are accommodated in a single housing part.

4. A device according to claim 3, wherein a centering bore for the motor and a bearing bore for the bearing are produced in one mounting position.

5. A device according to claim 1, wherein the bearing is a needle bearing with an outer bearing race and wherein said needle bearing establishes direct contact with a deflected journal projection.

6. A device according to claim 2, wherein the bearing is a needle bearing with an outer bearing race and wherein said needle bearing establishes direct contact with a deflected journal projection.

7. A device according to claim 3, wherein the bearing is a needle bearing with an outer bearing race and wherein said needle bearing establishes direct contact with a deflected journal projection.

8. A device according to claim 4, wherein the bearing is a needle bearing with an outer bearing race and wherein said needle bearing establishes direct contact with a deflected journal projection.

9. A device according to claim 1, wherein the pinion is positioned between the motor shaft and the bearing.

10. A device according to claim 3, wherein the pinion is positioned between the motor shaft and the bearing.

11. A device according to claim 4, wherein the pinion is positioned between the motor shaft and the bearing.

12. A device according to claim 5, wherein the pinion is positioned between the motor shaft and the bearing.

13. A device according to claim 1, wherein the bearing is positioned between the motor shaft and the pinion.

14. A device according to claim 3, wherein the bearing is positioned between the motor shaft and the pinion.

15. A device according to claim 4, wherein the bearing is positioned between the motor shaft and the pinion.

16. A device according to claim 5, wherein the bearing is positioned between the motor shaft and the pinion.

17. An axial adjusting device comprising: first and second discs which are rotatable and coaxially supported with respect to each other, one of the first or second discs is axially supported and one is axially displaceable against a resilient spring mechanism; and means between said first and second discs for converting rotational movement of one of said discs into axial displacement of one of said discs, wherein at least one of said discs is rotationally driveable by a motor which is incorporated into a housing, said motor having a shaft connected to a driving pinion comprising a journal projection which runs in a bearing supported in the housing.

18. A device according to claim 17, wherein the bearing is a needle bearing with an outer bearing race and wherein said needle bearing establishes direct contact with a deflected journal projection.

19. A device according to claim 18, wherein the pinion is positioned between the motor shaft and the bearing.

20. A device according to claim 18, wherein the bearing is positioned between the motor shaft and the pinion.
